(19) United States
(12) Patent Application Publication
(10) Pub. No.: US 2026/0340215 A1
(43) Pub. Date: Oct. 29, 2026

(54) Method and system for the computer-implemented design and/or (further) development and/or layout and/or service life optimization of machine elements of a metallurgical plant

(71) Applicant: SMS group GmbH, Mönchengladbach (DE)

(72) Inventor: Joachim OHLERT, Köln (DE)

(73) Assignee: SMS group GmbH, Mönchengladbach (DE)

(21) Appl. No.: 19/123,045

(22) PCT Filed: Dec. 6, 2023
(86) PCT No.: PCT/EP2023/084623

§ 371 Date: Apr. 21, 2025

(30) Foreign Application Priority Data
Dec. 7, 2022 (DE) 10 2022 213 177.0
Sep. 14, 2023 (DE) 10 2023 208 923.8

(51) Int. Cl. G06F 30/17; G06F 30/27; G06F 119/04

(52) U.S. Cl. CPC G06F 30/17; G06F 30/27; G06F 2119/04

(57) ABSTRACT

A method for the computer-implemented design and/or (further) development and/or layout and/or service life optimization of machine elements of a metallurgical plant, includes: calculating and/or providing at least one first data set comprising structural characteristic data of the machine element based on an assumed load and service life expectation of the machine element in operational use, detecting the actual load and/or load history of the machine element in the metallurgical plant and/or from the production history of the machine element in the form of application-related measurement data and information from operational use and/or production of the machine element; and returning and using the measurement data to calculate at least one second changed data set with structural characteristic data, which are optimized taking into consideration the installation situation of the machine element and/or the application-related measurement data.

### CROSS-REFERENCE TO RELATED APPLICATION

This application is a national stage application, filed under 35 U.S.C. § 371, of International Patent Application PCT/EP2023/084623, filed on Dec. 6, 2023, which claims the benefit of German Patent Applications DE 10 2022 213 177.0, filed on Dec. 7, 2022, and DE 10 2023 208 923.8, filed on Sep. 14, 2023.

### TECHNICAL FIELD

The disclosure relates to a method and system for computer-implemented design and/or (further) development and/or layout and/or service life optimization of machine elements of a metallurgical plant.

### BACKGROUND

Machine elements in drive trains of rolling mills are wear parts whose wear is based on numerous continuous and discontinuous, regular and sporadic, avoidable and unavoidable phenomena associated with the rolling process. Examples are peak torques when threading and removing the strip, alternating gripping and slipping of the strip, but also the continuous load due to the deformation of the rolled material. If a critical amount of wear is reached, the machine element must be replaced. For some machine elements such as rollers or rolls or, for example, toothed spindles or toothed spindle sleeves of roll drives, a repair/overhaul can extend the service life of the machine element with unchanged or improved performance.

In the structural layout of machine elements, the designer generally has no information about how the continuous reduction in functionality due to wear comes about. It is often the case that the exact load on the machine element during operational use and, in particular, the load history as well as the current state of the component are not known or only insufficiently known, such that a targeted improvement or further development of the product/machine element therefore cannot be performed.

### SUMMARY

The disclosure is therefore based on the object of providing a method and a system for the computer-implemented layout and/or (further) development and/or design and/or service life optimization of machine elements of a metallurgical plant, which takes this disadvantage into account.

The object is achieved by a method and by a system as disclosed and claimed.

According to a first aspect, a method is provided for the computer-implemented layout and/or design and/or (further) development and/or service life optimization of machine elements of a metallurgical plant, which comprises calculating and/or providing at least one first data set comprising structural characteristic data of the machine element based on an assumed load and service life expectation of the machine element in operational use, detecting the actual load and/or the production history of the machine element during manufacture and the load history of the machine element in the metallurgical plant in the form of application-related measurement data and information from the manufacturing process and the operational use of the machine element, and tracing and using the measurement data to calculate at least one second changed data set with structural characteristic data, which are optimized taking into consideration the installation situation of the machine element and/or the production-related and/or application-related measurement data.

In accordance with a first aspect, the method comprises an improvement in the static layout of the machine element. In particular, the method provides more and improved target values for the manufacture of the machine element, which are taken into consideration in the layout and, in particular, make the comparison of permissible and actual load more precise.

The additional detecting of actual values during manufacture enables the calculation or determination of correlations of these values with a load in operational use. The influence of the variation of the actual values of the machine element is immediately recognizable in this manner, such that the method provides additional safety in the design and layout of the machine element.

The term “design”/“layout” is to be understood as meaning that the method comprises both a layout of the component in the narrowest sense, i.e. with respect to material selection, dimensioning, surface design, heat treatment, etc., and a complete redesign of the component, for example in the sense of contour optimization or the like.

A further aspect of the disclosure comprises the dynamic layout of the component/machine element in the sense that a detection and evaluation of operating data is carried out and a comparison with the assumptions of the original, static layout and, in particular the production data, is carried out. This enables, in particular through the determination of an actual service life and a currently remaining residual service life, the possibility of adjusting process variables and limit values during the operational use of the component/machine element, as well as the possibility of adjusting the production process.

One aspect of the disclosure relates to automatic component optimization/automatic/automated further development of the machine element.

The method can be summarized in that it provides, according to one aspect, a quasi-dynamic layout and/or service life optimization and/or (further) development and/or design of machine elements of a metallurgical plant with the return and corresponding use of information and measurement data relating to the machine element from production and/or operational use. The structural and other characteristic data of the machine element are preferably automatically adjusted and optimized using the measurement data from the operational use and/or the data from the manufacture of the machine element. This can also be carried out repeatedly and iteratively with respect to a specific machine element, for example.

The method relates both to the computer-implemented layout and/or redesign of the machine element in the sense of a new manufacture and to the service life optimization of the machine element in the sense of a repair, maintenance or restoration.

Computer-implemented means that the method is performed at least partially automatically with the aid of computer hardware and software.

The manufacture of mechanically highly stressed machine elements typically comprises numerous steps up to the production of the raw part, e.g. melting, casting, forming, heat treatment, and finally to the manufacture of the produced machine element, e.g. by machining with a geometrically defined cutting edge, machining with a geometrically undefined cutting edge, welding, heat treatment. For all steps, the specified characteristic variables (target values), which often characterize the quality of the machine element (e.g., geometry and surface properties), and the values actually achieved (actual values) can be documented in detail and the usually extensive, often continuously occurring measured values (method parameters such as forces, torques or feed speeds) can be recorded and stored.

This data contains information/can be converted into information using suitable methods that show the direct influence of various manufacturing-related variables on the load and properties of the machine element during subsequent operation and reveal interactions and correlations that were previously unknown and undetected.

The exact geometry and surface shape, for example, influence the load that occurs during operation. The actual material composition and the heat treatment state influence, for example, the permissible load/load capacity.

The data can be used, preferably after it has been checked for plausibility and validated and converted into relevant information, to assess the performance of the machine element, taking into consideration the structural configuration on the one hand and the assumed load during operation on the other hand, and to quantitatively determine important static characteristic variables such as the expected service life. As a result, the accuracy and quality of the load prediction as part of the layout compared to the standard procedure, in which usually only a few target values from the manufacturing process are taken into consideration, improves.

It can also be determined, for example as part of a parameter study, how a variation of important process variables in production affects the load variables in operation and the static characteristic values of the layout calculated from them. In this connection, static characteristic values are those that are calculated using load variables that are based on assumptions or that are specified by plant limits or process restrictions and that are not compared and balanced with the actual load during operation. Once the static characteristic values have been calculated, they no longer change.

In contrast, dynamic characteristic values take into consideration the real loads during operation, which deviate from the forecast or which can only be mapped inaccurately due to the assumptions made in the layout, and possibly also the load history, which means, for example, that only a residual service life remains instead of the calculated service life.

In terms of dynamic layout and/or service life optimization (i.e., e.g., determination of safety factors as part of the mathematical proof of strength), the subsequent operation of the machine element within a metallurgical plant is also detected as comprehensively and seamlessly as possible.

The detection and evaluation of the measurement data using suitable methods and models and the comparison with the characteristic variables and measurement data from the production of the machine element allow the static characteristic values from the manufacturing phase to be converted into dynamic and current characteristic values that are valid for the respective operation and thus the specific application.

For example, actual service lives and current remaining service lives can be calculated, but also limit values with regard to the load on the machine elements, which must be observed during production, can be adjusted to the actual state of the machine element and the actual sequence of the process and can also be exceeded in a defined manner if the associated reduction in safety and/or service life, which is known at all times, is acceptable.

Conversely, particularly important machine elements that are expensive or difficult to procure or replace can, within certain limits, be relieved to the detriment of other machine elements, if precise information on the currently occurring and currently permissible load is available.

Preferably, the method comprises changing the boundary conditions assumed for the calculation and/or provision of the structural characteristic data both during manufacture and during operation in the event of a deviation being detected between the assumed boundary conditions and a deviation determined from the measurement data and/or from information obtained with respect to the actual parameters and loads during the manufacturing process and operation, and calculating and/or specifying optimized structural characteristic data taking into consideration the actual load. This optimized characteristic data was also referred to above as dynamic characteristic data or characteristic values.

It is therefore possible to adjust important process variables in such a manner that the load on the machine element corresponds to the prediction determined in the layout or that it is higher or lower on a targeted basis if thereby, for example, machine elements can be relieved or process-related or product-related objectives can be achieved. In doing so, precise knowledge of the actual values/specified or calculated characteristic data based on assumed loads along with a comparison with the measured values from operational use and, above all, the deviation between target values and actual values are of great importance.

The individual method steps are preferably performed in the order in which they are listed and can be repeated if applicable in order to achieve an iterative optimization of the machine element.

Preferably, the measurement data are checked for plausibility and/or validated on the basis of physical models and/or artificial intelligence.

The method can further comprise the method step of contour optimization of the machine element on the basis of the detected actual load and/or load history of the machine element in operational use.

The method can further comprise additionally or alternatively one or more of the steps of optimizing the machine element with regard to the surface, the material used, and a heat treatment of the machine element.

With a variant of the method, an automated verification of given assumptions and/or or derivation of new assumptions for the layout of the machine element and/or the establishment of new relationships between the variables relevant for the layout of the machine element is provided.

In one variant, the method can comprise the method step of varying on a targeted basis the load on the machine element in operational use for increasing the database of the measurement data. In doing so, for example, a targeted exceeding of limit values/load limit values of the machine element in operational use can be provided in order to achieve process optimization with regard to the component, process and product (rolled product).

The plausibility check and/or validation of the measurement data and/or the method step of contour optimization and/or the further optimization steps are preferably performed using methods that are based on machine learning methods.

The calculation and/or specification of changed structural characteristic data can also be performed using methods that are based on machine learning methods.

The method comprises the possibility of making changes to the machine element by recording comprehensive data and converting it into relevant information, thereby increasing its performance and enhancing its functionality. Linking data from production and operation with data that characterizes the current state of the machine element can allow not only a more precise layout of the machine elements, but also an optimization of the structural design.

If, for example, contour optimization is carried out on the basis of a measurement, thereby the stresses acting on the machine element can be reduced. An example of such a measurement is the determination of wear-related material removal in the region of a toothed spindle sleeve that is in direct contact with a roll journal. As a result of the measurement and subsequent evaluation and assessment of the underlying mechanism, the geometry of a functional surface of the tooth spindle sleeve can be changed, for example. The complexity of the procedure increases if instead a plurality of or even numerous measurements are evaluated together by means of suitable methods and a plurality of or even numerous measures for machine element optimization are derived from them by means of suitable methods.

By means of suitable methods and special calculation methods on the basis of physical models and/or artificial intelligence, the influence of process variables and plant settings on the machine element load during operation, which is calculated within the framework of the layout of the machine element, can be verified and made more precise. For this purpose, in addition to the variables such as rolling force or temperature that are measured directly or determined with the aid of process models, for example a rolling plant, such as a pass plan model or the profile, contour and flatness model, further variables are preferably measured/determined that allow direct conclusions to be drawn about the load on the machine element. This can be, for example, a current measurement of geometry and/or surface or a local measurement of forces or stresses. With additional measurements that allow, for example, a direct statement about the wear state or an indirect mathematical determination of the remaining service life, the relationship between the above-mentioned influencing variables and the correlated load, on the one hand, and the machine element state and safety/service life, on the other hand, can be determined likewise by means of methods and calculation methods on the basis of physical models and/or artificial intelligence. These two types of measurements also improve the quality of the layout and make possible the verification of important assumptions, such as the relationship between load variables and wear of the machine element, and the establishment of new correlations.

The relationship between the average or maximum torque transmitted by a machine element, such as a toothed spindle sleeve, on the one hand, and the wear of the internal surfaces of the toothed spindle sleeve that are in contact with the journal of the work roll, on the other, is a relationship that can initially be estimated using assumptions. This wear can lead to failure and thus to the end of the service life of the toothed spindle sleeve. The method makes it possible to improve these assumptions by comparing the detected and/or measured data. The relationship between characteristic variables and parameters during the manufacture of the machine element and its subsequent loading during operation makes possible the improvement of assumptions already made or the provision of new relationships or assumptions.

The relationship between characteristic variables and parameters during the manufacture of the machine element and its subsequent load during operation, which is often not yet known to the same extent as that between characteristic variables and parameters during operation and the load during operation, can also be analyzed by means of methods and calculation methods on the basis of physical models and/or artificial intelligence and verified in the same manner as the procedure described above.

Examples of such artificial intelligences are neural networks, adaptive algorithms, evolutionary algorithms, genetic algorithms and the like. Examples known from the prior art are, among others: Bayesian belief networks, decision trees, so-called hidden Markov models, case-based reasoning, k-nearest neighbors, self-organizing maps, instance-based learning, support vector machines, artificial neural networks (ANN), recurrent neural networks (RNN), deep neural networks (DNN), or convolutional neural networks (CNN). Any conceivable combination of such models can also be used.

The comprehensive data situation and the evaluation of the data with, e.g., analytical and numerical methods allow process optimization with regard to the machine element, but also to the same extent with regard to the process, e.g. stability, output, use of alloying elements and energy, use of input materials, and product, e.g. properties, quality, reproducibility. This means that plant limits and process-related limit values can be shifted if the current permissible load on the machine element is known, which can give the operator of the plant more freedom in production or increase the quality of the product. This can be the case in a hot rolling mill, for example, if larger (or smaller) passes and/or higher or lower temperatures are used and alloying elements can be saved or better product properties can be achieved as a result.

The information measured directly or obtained by evaluation can be used in order to further develop a component. In addition, component optimization can also be performed automatically by initiating the necessary changes to the component with the aid of suitable rules and algorithms or highly complex dynamic and iterative models. While changes to the process to change the load can be made immediately, any changes to the component for reducing the occurring load or to increase the permissible load must be performed by the manufacturer of the component and the plant. However, they can be triggered automatically, and the ordering process and the actual development process can also be automated if the infrastructure and suitable development tools are available. Finally, the method can be used in order to design and manufacture customer-specific components on the basis of the actual load. These take into account the real driving mode of the operational application of the customer and thus the actual load on the components and are individual solutions that are difficult for other suppliers of mechanical components to implement.

Preferably, the characteristic data/characteristic variables of manufacture are selected from a group of data comprising material characteristic values and/or material composition, surface properties, along with the geometric dimensions and contours of the machine element.

Preferably, the measurement data from the operational use of the machine element is selected from a group of data comprising the tribological characteristic values of the machine element in the specific installation situation, temperatures, torques, rotational speeds and static loads.

Preferably, the measurement data are at least partially returned from a process control and management system of a steelworks plant or a continuous casting plant or an annealing furnace or a hot-dip galvanizing line or a rolling mill or a strip treatment plant or a forging plant or a casting-rolling plant into a device for the computer-aided design of machine elements and used to optimize the characteristic data/characteristic variables of the machine element.

Preferably, the machine element is selected from a group of machine elements comprising the rolls of a rolling mill, roller table rollers of a rolling mill, linear guides of roller tables, rolling mill stands and upsetting stands along with drive shafts and gear parts and toothed spindles of rolling mill stands.

The disclosure further comprises a system for designing or laying out and/or optimizing the service life and/or further developing machine elements of a metallurgical plant, comprising at least one device for the computer-aided design of machine elements and means for measuring, detecting and storing operating data from the operational use of the machine element, wherein the system is configured to perform the method described above.

The invention is explained below by means of an example of an exemplary embodiment and with reference to the accompanying drawings.

### BRIEF DESCRIPTION OF THE DRAWINGS

FIG. 1 is a perspective view of a finishing line of a rolling plant as a metallurgical plant,

FIG. 2 is a perspective view of the drive side of a roll milling stand with parts of the drive as machine elements to be designed according to the method,

FIG. 3 a cross-section of a toothed spindle sleeve as a machine element and

FIG. 3b a perspective longitudinal section through the tooth spindle sleeve.

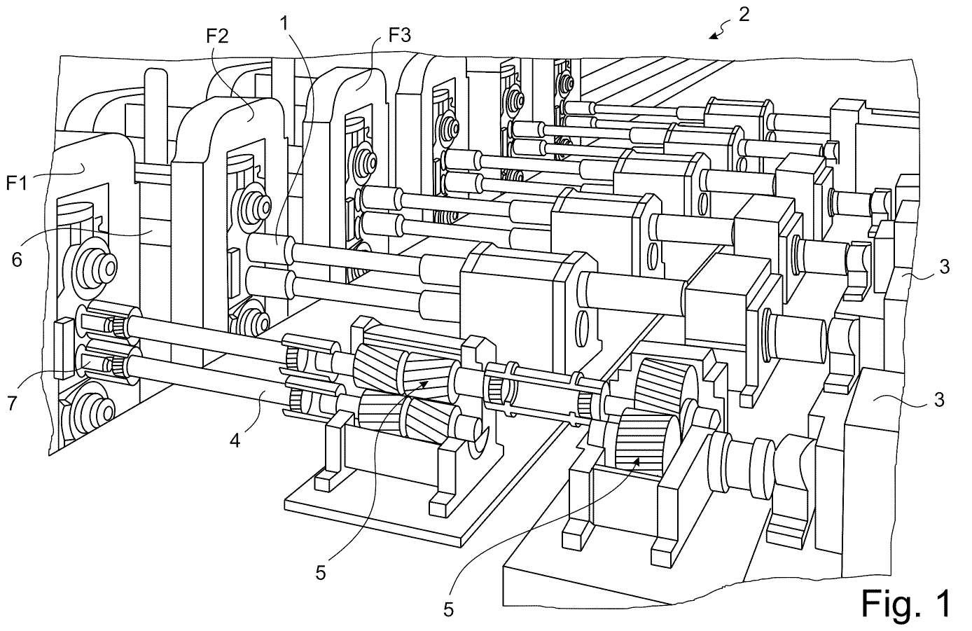

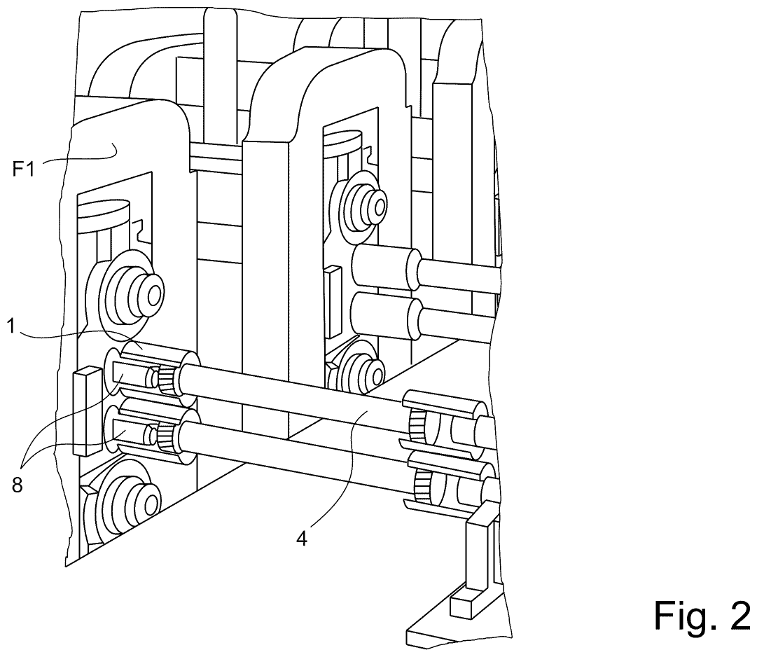

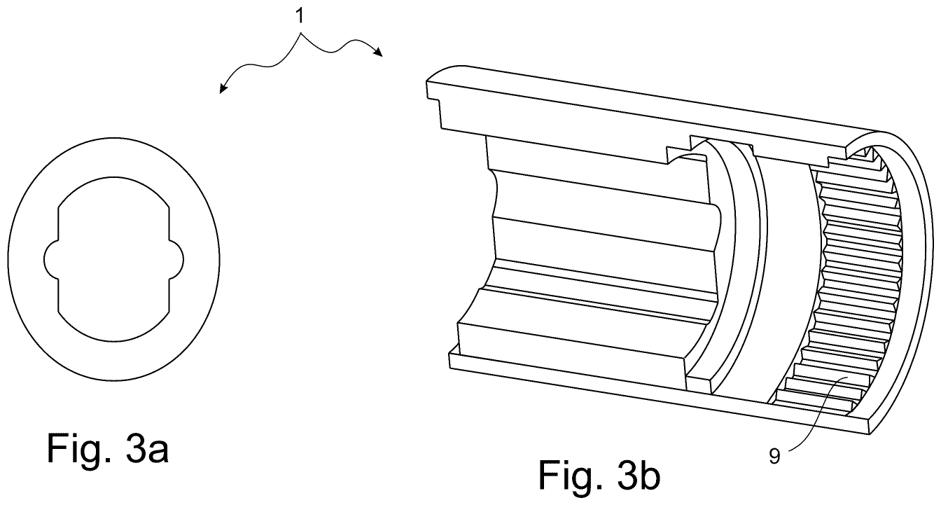

### DETAILED DESCRIPTION

The invention is described below with reference to a further development of toothed spindle sleeves 1 as machine elements of drive trains for rolling mill stands F1-Fn of a finishing line 2 of a hot rolling plant for steel. In a known manner, the finishing line 2 comprises a plurality of individual rolling mill stands F1-FN, which are part of the hot rolling plant as a metallurgical plant.

Such a finishing line 2 can, for example, comprise up to eight rolling mill stands F1-Fn, which in each case is driven by means of drives 3 via toothed spindles 4 as drive shafts. The toothed spindle shafts 4 are in each case connected laterally to a gearbox 5 via toothed spindle sleeves 1 and are part of the drive train for the rolling mill stands F1-Fn. On the drive side of the rolling mill stands F1-FN, an upper work roll 6 and a lower work roll 7 are connected to the relevant toothed spindle shaft 4 via a work roll journal 8 with a toothed spindle sleeve 1, wherein the toothed spindle shaft 4 engages with a circumferential toothing 9 in a corresponding toothing of the toothed spindle sleeve 1. On the side of the toothed spindle sleeve 1 opposite the toothing 9, this is provided with a cross-sectional profile that is complementary to the work roll journal 8.

Process variables that are relevant for the load on the toothed spindle sleeve 1 and that change over the course of the finishing line 2 include the rotational speed n and the torque M, which can change, for example, from the rolling mill stands F1 to F7 as follows:

| Rolling mill stand | F1 | F2 | F3 | F4 | F5 | F6 | F7 |
|---|---|---|---|---|---|---|---|
| n [rpm] | 21 | 46 | 81 | 114 | 148 | 179 | 196 |
| M [kNm] | 2430 | 1460 | 770 | 340 | 250 | 150 | 70 |

Due to the reduction in thickness of the rolled material, the rotational speed of the work rolls increases significantly from an upstream rolling mill stand F1 to a downstream rolling mill stand F7, as can be seen in the table above. The torque M decreases accordingly.

The load on the toothed spindle sleeve 1 in operational application also depends on the installation situation, for example depending on whether the toothed spindle sleeve 1 is connected to the toothed spindle shaft 4 on the stand side or on the gearbox side or whether it is arranged in the drive train of an upper work roll 6 or a lower work roll 7. The corresponding data, which can be provided in the form of measurement data, and the information in which stand F1 to F7 of the finishing line 2 the relevant toothed spindle sleeve 1 is arranged, are important for optimizing the service life of the toothed spindle sleeve. With the aid of simple sensors, the position and direction of rotation of the various toothed spindle sleeves 1 in the finishing line 2 can be determined. An evaluation of the measurement data supplied by the sensors also provides information as to whether the relevant toothed spindle sleeve 1 is always inserted at the same position or whether it is installed and operated at a different position within the rolling mill stand F1-Fn or in a different rolling mill stand F1-Fn.

On the one hand, essential load data for the toothed spindle sleeve, such as rotational speed, speed, rolling force and rolling torque, can be estimated. On the other hand, rotational speed and speed can also be measured with the aid of additional sensors. The values of the rolling force and torque can alternatively or additionally be taken from the automation systems/a higher-level process control of the rolling plant or corresponding databases.

The measured or otherwise determined values are assigned to each individual toothed spindle sleeve 1 for the entire operating time. In this manner, an individual load history is created for each toothed spindle sleeve 1 as a load collective, with all available and relevant measurement data as a function of time.

The load collective is used as the basis for the layout.

Toothed spindle sleeves 1, which are always used in the same place, must be able to withstand the load occurring there permanently or for a defined period of time. Toothed spindle sleeves 1 that are subjected to high forces and torques can be designed differently from those that are operated at low loads. Toothed spindle sleeves 1 that are operated at high rotational speeds can be designed differently from slow-running toothed spindle sleeves.

For toothed spindle sleeves 1 that are used in both positions within at least one stand, it is taken into consideration that the load is of an alternating rather than a pulsating nature based on the change in the direction of rotation and that the permissible load is thereby reduced if the design remains unchanged.

The most important criteria, guidelines and algorithms for the layout are stored in corresponding software based on machine learning methods. This software is trained in such a way that the individual layout of the machine element, in particular the toothed spindle sleeve 1, runs automatically and without the intervention of a designer.

The load collective can be used in a next and further method step as the basis for an individual further development of the toothed spindle sleeve 1 that is optimally adapted to the respective application.

Toothed spindle sleeves 1, which are always used in the same place, must be able to withstand the loads occurring there permanently or for a defined period of time. Toothed spindle sleeves 1, which are subjected to high forces and torques, are dimensioned larger using the method. These can be equipped with a further developed and thereby improved geometry of the toothing 9 and/or the roll journal mount.

Toothed spindle sleeves 1, which are operated at high rotational speeds, can have a different structural configuration and be manufactured from different materials and using different production methods than slow-running toothed spindle sleeves 1.

Toothed spindle sleeves 1, which are used in various rolling mill stands F1-Fn, are optimized on a targeted basis for their heterogeneous and complex load scenario.

For toothed spindle sleeves 1 that are only used at one position within a rolling mill stand F1-Fn, a pulsating load can be assumed instead of an alternating load, but above all an asymmetrical tooth form can be selected for the toothing 9. This has the result of a restriction to one direction of rotation, but higher torques can then be transmitted in this direction. If higher torques are not required, a smaller and cheaper size can be selected.

For toothed spindle sleeves 1 in particular, which are used in various rolling mill stands F1-Fn, but also for all other toothed spindle sleeves, the data-supported load analysis can show that a technically optimal or economically favorable layout or design is difficult to achieve based on the load situation/the load history. The software can then propose alternative suggestions for changed operation or be implemented automatically. On the one hand, this can mean that the rolling mill stand in which the toothed spindle sleeve 1 is currently located is relieved with regard to the critical variables, or on the other hand, that the toothed spindle sleeve 1 is used in a specific rolling mill stand F1-Fn, but not in another.

Furthermore, with the method, a computer-aided analysis of all load histories and all measures, derivation and manual or automated application of design principles, if applicable taking into consideration customer specifications as additional boundary conditions, can be provided.

### LIST OF REFERENCE SIGNS

1 Toothed spindle sleeve
2 Finishing line
3 Drives
4 Toothed spindles
5 Gearbox
6 Upper work roll
7 Lower work roll
8 Work roll journal
9 Toothing
F1-Fn Rolling mill stands
n Rotational speed
M Torque

1.-15. (canceled)

16. A method for computer-implemented design and/or (further) development and/or layout and/or service life optimization of a machine element of a metallurgical plant, comprising:
calculating and/or providing at least one first data set comprising structural characteristic data of the machine element based on an assumed load and/or service life expectation of the machine element in operational use;
detecting an actual load and/or load history in the metallurgical plant and/or from a production history of the machine element in the form of application-related measurement data and/or information from operational use and/or production of the machine element; and
returning and using the application-related measurement data to calculate at least one second changed data set with structural characteristic data for a changed component, which are optimized taking into consideration an installation situation of the machine element and/or the application-related measurement data.

17. The method according to claim 16, further comprising
changing the assumed load and/or service life expectation when a deviation is detected between the assumed load and an actual load derived from the application-related measurement data and/or information, and
calculating and/or specifying optimized structural characteristic data taking into consideration the actual load.

18. The method according to claim 16,
wherein steps of the method are performed in order in which they are listed and iteratively repeated.

19. The method according to claim 16,
wherein the measurement data are checked for plausibility and/or validated.

20. The method according to claim 16,
further comprising contour optimizing the machine element on the basis of the actual load and/or load history of the machine element in operational use.

21. The method according to claim 16,
further comprising one or more of the steps of optimizing the machine element with regard to a surface, a material used, and a heat treatment.

22. The method according to claim 16, further comprising
automatedly verifying given assumptions and/or or derivation of new assumptions for the layout of the machine element, and/or
establishing of new relationships between variables relevant for the layout of the machine element.

23. The method according to claim 16, further comprising
varying the load on the machine element in operational use for increasing a database of the measurement data.

24. The method according to claim 16, further comprising
performing a plausibility check and/or validation of the measurement data and/or the method step of contour optimization and/or the further optimization steps using methods that are based on machine learning methods.

25. The method according to claim 16,
wherein calculating and/or specifying changed structural characteristic data is performed using methods based on machine learning methods.

26. The method according to claim 16,
wherein the characteristic data are selected from a group of data consisting of material characteristic values, material composition, surface properties, geometric dimensions, and contours of the machine element.

27. The method according to claim 16,
wherein the measurement data are selected from a group of data consisting of tribological characteristic values of the machine element in the installation situation, temperatures, torques, rotational speeds and static loads.

28. The method according to claim 16,
wherein the measurement data are at least partially returned from a process control and management system of a steelworks plant, a continuous casting plant, an annealing furnace, a hot-dip galvanizing line, a rolling mill or a strip treatment plant, a forging plant or a casting-rolling plant into a device for computer-aided design of machine elements.

29. The method according to claim 16,
wherein the machine element is selected from a group of machine elements consisting of rollers of a rolling mill, roller table rollers of a rolling mill, linear guides of roller tables, rolling mill stands and upsetting stands, drive shafts, gear parts, and toothed spindles of rolling mill stands.

30. A system for the design and/or layout and/or service life optimization of machine elements of a metallurgical plant, comprising:
a device for computer-aided design of machine elements; and
means for measuring, detecting and storing operating data from the operational use of the machine element,
wherein the system is configured to perform the method in accordance with claim 16.
